(19) United States
(12) Patent Application Publication
(10) Pub. No.: US 2006/0144103 A1
(43) Pub. Date: Jul. 6, 2006

(54) Multimode lock with a visual indicator to the selected mode

(76) Inventor: David G. Blanch, Nottinghill (AU)

Correspondence Address: Martin P. Hoffman;HOFFMAN, WASSON & GITLER, P.C., Suite 522, 2461 South Clark Street, Arlington, VA, 22202, US

(21) Appl. No.: 11/248,233

(22) Filed: Oct. 13, 2005

(30) Foreign Application Priority Data
Dec. 22, 2004 (AU) 2004240257

(51) Int. Cl. E05B 17/00; E05B 41/00

(52) U.S. Cl. 70/330; 70/432; 70/DIG. 59

(57) ABSTRACT

A multimode lock for use with a door comprises a mechanism to enable the lock to change from a passage mode, safety mode and a secure mode, and further contains a visual identification means (typically different colours), to enable the particular mode of the lock to be seen visually and without needing to touch the lock.

### FIELD OF THE INVENTION

This invention is directed to a lock which has multiple modes, by which is meant that the lock can be changed from a passageway mode (for example), to a safety mode (for example) and to a secure mode (for example), and where each mode of the lock can be identified by a visual indicator that may be a LED display, or some other type of visual indicator. The lock will typically be used as a door lock.

### BACKGROUND ART

Traditionally, a front door lock has been able to adopt a lock mode and an unlocked mode, typically by turning a key in the lock. More recently, locks have been more sophisticated and have multiple modes. These modes may include a “passage mode” by which is meant that the door can be opened from the inside and the outside simply by operating the door handle, a “safety mode” by which is meant that the door is locked from one side (typically the outside) but can be opened from the inside by turning the handle, and a “secure mode” by which is meant that the door is locked from both the inside and the outside.

It is well-known to provide a mechanism which is always and only in the passage mode and this mechanism is widely used on internal doors.

It is also well known to provide a mechanism that enables the door to be operated from the inside but not from the outside. This type of mechanism is commonly used on bathroom doors and external doors.

It is known to provide a lock that can be “deadlocked” such that the lock can not be operated either from the inside or the outside without a key, a snib etc.

It is known to provide an indicator on the outside of a door to let the person on the outside of the door know if the door is locked. A very well-known example is the public toilet door lock which has a “engaged/vacant” indicator which is operated from the inside of the door and upon locking of the door. These locks have restricted modes which are usually a lock mode and an unlocked mode.

There is an advantage in providing a handle and lock assembly that can be fitted to a door and which can provide multiple modes including a passage mode, a safety mode and a secure mode. Such an assembly may comprise a handle and a snib and a key to enable a person to select the desired mode.

However, there is a disadvantage in having such an assembly with multiple modes in that it is not often easily recognisable in which mode the assembly is in at any particular time. Sometimes, the angular position of the snib can be viewed to indicate one mode of the lock, although this is not easily done.

A person unaware that a lock is in the secure mode or safety mode may wish to operate the lock and may apply excessive force thinking that the lock is in the passage mode and this may damage the lock components.

Also, a person leaving the house and wishing to move the lock into the secure mode would like to immediately see that the lock is in the secure mode without needing to fiddle with the lock unnecessarily to see if that is the case.

Therefore, there would be an advantage, in regard to a multimode lock, if it were possible to provide a visual indicator that would indicate to a person in which mode the lock is in.

It will be clearly understood that, if a prior art publication is referred to herein, this reference does not constitute an admission that the publication forms part of the common general knowledge in the art in Australia or in any other country.

### BRIEF SUMMARY OF THE INVENTION

It is an object of the invention to provide a multimode lock with a visual indicator that enables the mode of the lock to be identified without needing to fiddle with the lock or to operate the lock handle to see in which mode the lock is in.

It is a further optional object of the invention to provide a multimode lock that may overcome at least some of the above-mentioned disadvantages or provide the consumer with a useful or commercial choice.

In one form, the invention resides in a multimode lock comprising a lock body, a handle, and a mechanism that enables the lock to have a passage mode, a safety mode and a secure mode, and visual indication means on the lock that enables the mode of the lock to be identified visually.

The visual indication means may comprise different colours for the different modes of the lock (e.g. red for secure, yellow for safety and green for passage), different letters for the different modes of the lock, different numbers for the different modes of the lock, a combination of letters, numbers, colours; different shapes for the different modes of the lock, or any combination thereof, as long as the indication means enables the mode of the lock to be seen visually.

It is preferred that the visual indication means is on the lock body and separate from the handle, the snib (if present), or the key barrel (if present).

The prominence of the visual indication means may vary depending on the size of the lock, the use of the lock etc. Thus, the visual indication means may be relatively discreet (e.g. a circle having a diameter of between 2-5 millimetres) or more prominent.

The visual indication means may comprise a separate member that can move between a hidden position and a visual position. The separate member may comprise a tab, a flag, or any other type of shape that can be somewhere on the lock and visible when the lock is in a certain mode.

The visual indication means may be positioned in the lock body and behind the face of the lock, and the lock may be provided with an opening to enable the visual indication means to be viewed through the opening.

The opening in the lock may be of any suitable size and shape and may be circular, oval, elongate, rectangular, have an irregular shape and the like; and may have a size of a few millimetres.

If the visual indication means is behind the face of the lock, it may comprise at least one member that may move to present a different indicia through the opening in the lock depending on the mode of the lock. The member may rotate, slide, twist or move in another way to present the different indicia through the opening in the lock. The indicia may comprise a colour change, letters, numerals, etc. The member may be moved by one or more components in the lock to the different positions depending on the mode of the lock, and it is not considered that the invention should be limited to any particular mechanism by which the visual indication means is operated.

In another form, the visual indication means may comprise a light. The light may comprise a light emitting diode (LED). It is preferred that the LED is of the type that can emit light of different colours such that a single LED can be used to visually identify different modes of the lock. However, it is also envisaged that the lock may comprise a plurality of lights, each identifying a particular mode.

The lock may comprise a purely manual lock which is operated by the key, snib, handle etc. Alternatively, the lock may comprise an electronic lock which contains the required circuitry and motor to enable at least some of the modes of the lock to be obtained remotely, typically by a remote control.

If the lock is a purely manual lock, it is preferred that the visual identification means does not comprise a light, as this requires circuitry and a source of electrical power to be provided to the lock. However, if the lock is an electronic lock, it is preferred that the visual identification means comprises a light such as an LED. However, it is also preferred that if the lock is an electronic lock, that the lock comprises both the manual visual identification means and the LED or other light source.

### BRIEF DESCRIPTION OF THE DRAWINGS

An embodiment of the invention will be described with reference to the following illustrations in which:

FIG. 1. Illustrates a multimode lock in a passage mode.

FIG. 2. Illustrates the lock in the secure or safety mode.

FIG. 3. Illustrates the various snib positions.

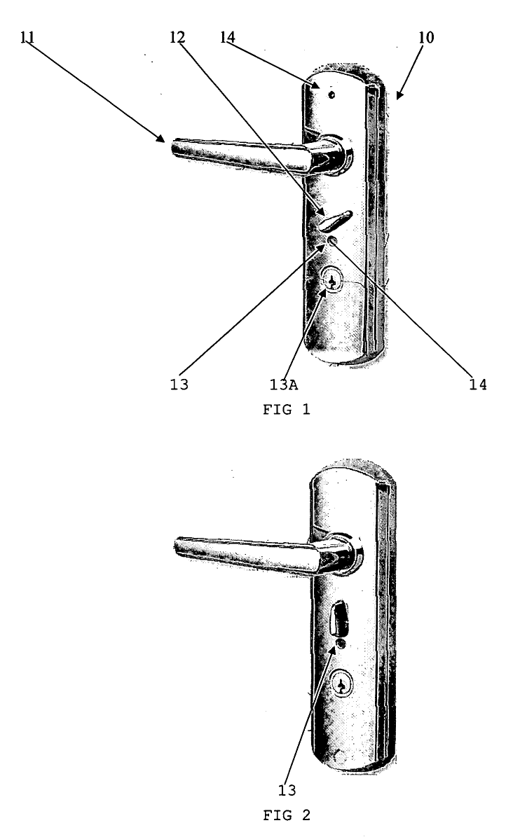

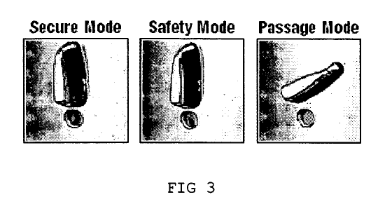

### DETAILED DESCRIPTION

Referring to the illustrations, there is illustrated an entry lockset 10 which comprises a lock body, a handle 11, a snib 12, a key barrel 13A as is quite known.

The lockset 10 has three different modes being a secure mode, a safety mode and a passage mode. These modes are determined by the internal mechanism of the lock and operable by the handle/snib/key barrel or by a remote control.

In the secure mode, the lockset is locked from both the inside and the outside. In the safety mode, the lockset is locked from the outside only and free to exit from the inside. In the passage mode, the lockset is free to enter from the outside and free to exit from the inside.

As illustrated in the figures, it is not easy to determine the particular mode of the lock just by a visual inspection of the lock itself.

For this reason, the lockset is provided with a visual indication means. In the particular embodiment illustrated, the visual indication means comprises an opening 13 in the face of the lock, and a member 14 which is positioned inside the lock and part of which is visible through opening 13. The member may comprise a rotating disk, or an elongate sliding strip etc. The member is provided with three separately identifiable indicia which in the particular embodiment comprise the colour red, the colour yellow and the colour green which are applied to the disk/strip such that upon movement of the lock into a particular mode, a particular colour is visible through the opening 13 in the front of the lock. Also, in the particular embodiment, it is considered suitable to use the colour red for the secure mode, the colour yellow for the safety mode and the colour green for the passage mode, although it should be appreciated that no particular limitation should be placed on the invention merely by these particular colours.

The lockset 10 can be an electronic lock which uses a remote control to operate the lock between at least some of the modes. With this mechanism, the lockset will contain a small electric motor to operate the various components between the various modes. The lockset will therefore be electrically powered. With this variation, it is preferred that the front of the lock is provided with an LED 14 which is of the type that can emit light of different colours. The LED can emit a red/yellow/green colour (for example) depending on the mode of the lock. An advantage of this is that at night time, the mode of the lock can be clearly seen without needing to manipulate the lock. With the electronic lock, it is preferred that the non electronic visual indicia 13 is also present as this enables the “manual” lock to be converted to the electronic lock without needing excessive change of the lock components.

For the manual lock, the visual indicia can be chosen to be easily seen even under low light conditions, and therefore can be “glow in the dark” or illuminated indicia, or otherwise treated.

Thus, the separate modes of a multimode lock can now be easily visualised.

For instance, in a motel or hotel, a security officer can easily view the status of the door lock by the visual indicator rather than needing to test each door.

Throughout the specification and the claims (if present), unless the context requires otherwise, the term “comprise”, or variations such as “comprises” or “comprising”, will be understood to apply the inclusion of the stated integer or group of integers but not the exclusion of any other integer or group of integers.

Throughout the specification and claims (if present), unless the context requires otherwise, the term “substantially” or “about” will be understood to not be limited to the value for the range qualified by the terms.

It should be appreciated that various other changes and modifications can be made to any embodiment described without departing from the spirit and scope of the invention.

1. A multimode lock comprising a lock body, a handle operated mechanism, a key operated mechanism and a selector operated mechanism to enable the lock to operate between a secure mode, a safety mode and a passage mode, and visual identification means on the lock to enable the particular mode to be observed visually.

2. The lock as claimed in claim 1, wherein the visual identification means is operated to move from one said mode to another said mode by the handle operated mechanism, the key operated mechanism and the selector operated mechanism.

3. The lock as claimed in claim 2, wherein the visual identification means comprises an opening in the lock body, and a member in the lock body which contains different indicia in respect of each mode of the lock, and which is movable upon movement of the lock from one said mode to another said mode, the indicia being viewable through the opening in the lock body.

4. The lock as claimed in claim 3, wherein the indicia comprise different colours, different numbers, different letters, and/or different shapes.

5. The lock as claimed in claim 1, wherein the visual identification means comprises a light.

6. The lock as claimed in claim 5, wherein the light is a LED.
